(19) United States
(12) Patent Application Publication
(10) Pub. No.: US 2012/0191726 A1
(43) Pub. Date: Jul. 26, 2012

(54) RECOMMENDATION OF GEOTAGGED ITEMS

(75) Inventors: Matthew A. Markus, Seattle, WA (US); Geoffrey W. Simons, Seattle, CA (US)

(73) Assignee: PEOPLEGO INC., Seattle, WA (US)

(21) Appl. No.: 13/355,427

(22) Filed: Jan. 20, 2012

Related U.S. Application Data
(60) Provisional application No. 61/436,571, filed on Jan. 26, 2011.

(51) Int. Cl. G06F 17/30

(52) U.S. Cl. 707/748; 707/E17.084

(57) ABSTRACT

A system, method and computer program product are disclosed for presenting geotagged items to an end user. A location fix and heading are obtained and candidate items are identified in the vicinity of the location fix. A plurality of factors, including proximity to the location fix and proximity to a predicted trajectory determined from the heading, are used to calculate a set of scores for each candidate item. The sets of scores are used to select a candidate item to be presented to the end user.

### CROSS REFERENCE TO RELATED APPLICATIONS

This application claims the benefit of U.S. Provisional Application No. 61/436,571, filed Jan. 26, 2011, which is incorporated by reference in its entirety.

### BACKGROUND

1. Field of Art

The disclosure generally relates to the field of recommender systems, and more specifically, the selection of specific items from a corpus of geotagged recommender content.

2. Description of the Related Art

Global Positioning System (GPS) enabled mobile devices with either Text-to-Speech (TTS) or media player functionality are giving individuals the power to mediate reality in new and interesting ways. Simultaneously, the growing availability of geocoded or geotagged items, including, but not limited to, short messages, news articles, blog posts, encyclopedia entries, and telemetric data, is creating a virtual landscape of incredible size and scope. There is a need to integrate these elements so that people can passively receive information about relevant activities, promotions, thoughts, feelings, and experiences associated with localities.

### BRIEF DESCRIPTION OF DRAWINGS

The disclosed embodiments have other advantages and features that will be more readily apparent from the detailed description, the appended claims, and the accompanying figures (or drawings). A brief introduction of the figures is below.

FIG. (FIG. 1 is a block diagram illustrating a content-based recommender system in accordance with one embodiment.

FIG. 2 is a block diagram illustrating one embodiment of the recommendation server shown in FIG. 1.

FIG. 3 is a table illustrating exemplary field names and item data format, in accordance with one embodiment.

FIG. 4 is a table illustrating exemplary field names and format of event data, in accordance with one embodiment.

FIG. 5 is a flow diagram of a process for making a recommendation, in accordance with one embodiment.

FIG. 6A is a depiction of exemplary candidate items relative to a location fix and heading.

FIG. 6B is a depiction of a Monte Carlo simulation distributing points around the location fix depicted in FIG. 6A.

FIG. 6C is a depiction of a Monte Carlo simulation distributing points along the heading depicted in FIG. 6A.

FIG. 7 is a table showing conditional and marginal emission probabilities calculated for some exemplary candidate items in accordance with one embodiment.

FIG. 8 illustrates one embodiment of components of an example machine able to read instructions from a machine-readable medium and execute them in a processor.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

A system, a method and a computer program product are disclosed for recommending geotagged items collected from one or more digital sources. A location fix and heading obtained from a mobile device, along with historical listening preferences and histories of end-users, are utilized to select a relevant item to be presented to an end-user.

One aspect of the disclosed recommender is that it does not adopt the filtering approach commonly employed by many content-based recommender systems. Under the filtering approach, a one-dimensional stream of candidate items is input into a recommender and, for each item, the probability of a given end-user liking the candidate item is calculated. Candidate items with a probability that exceeds a certain threshold are then recommended to the end-user, often as a list on a two-dimensional display device. An example of the filtering approach is Bayesian spam filtering, wherein the recommender monitors an end-user's incoming emails and routes them to either a junk folder or inbox folder.

In contrast to conventional systems, a disclosed recommender uses a funneling approach. The recommender takes in a two-dimensional (spatial) or three-dimensional (spatiotemporal) collection of candidate items, calculates emission probabilities for them in the context of a given end-user, and then uses these probabilities to recommend a candidate item for presentation to the end-user. Repeated, or iterative, application of the funneling approach yields a one-dimensional stream of relevant items as the end-user moves either physically or virtually through space-time. One advantage of this approach is that it minimizes interruptions or “dead air” since the recommender will continue to present items to the end user as long as previously un-presented items are available within the region the end-user is exploring.

Another aspect of the disclosed recommender relates to how feedback is handled. Typically, a content-based recommender system makes recommendations to an end-user based on items the end-user has previously liked. Getting feedback from an end-user is a slow process, however, so existing content-based recommenders have typically suffered from a “cold-start” problem. That is, they tend to make poor recommendations until sufficiently customized via feedback. When an end-user is primarily restricted to supplying feedback through a mobile device, the “cold-start” problem is exacerbated. For example, it may be dangerous, or even illegal, to provide feedback while in certain situations, such as while driving. The disclosed recommender is not solely dependent on feedback; rather, it is a hybrid system that is composed of learning components as well as components that model facets of human attention in order to make extrapolations about an end-user's interests.

Still another final aspect of the disclosed recommender is its incorporation of social information. A content-based recommender system, by definition, makes recommendations based off the content, or features, of the items under its consideration. A collaborative recommender system makes use of the opinions of other end-users when formulating recommendations. For example, the disclosed recommender utilizes some of the benefits of collaborative recommenders by preprocessing social information into features (e.g., popularity, sponsorship, etc.) of the items themselves.

### System Overview

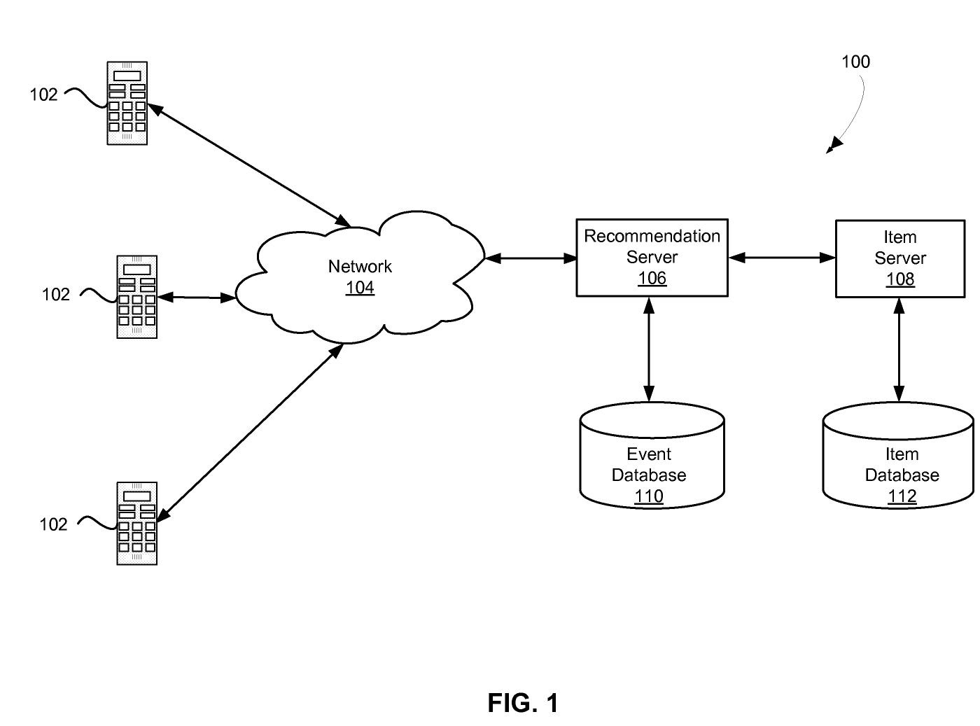

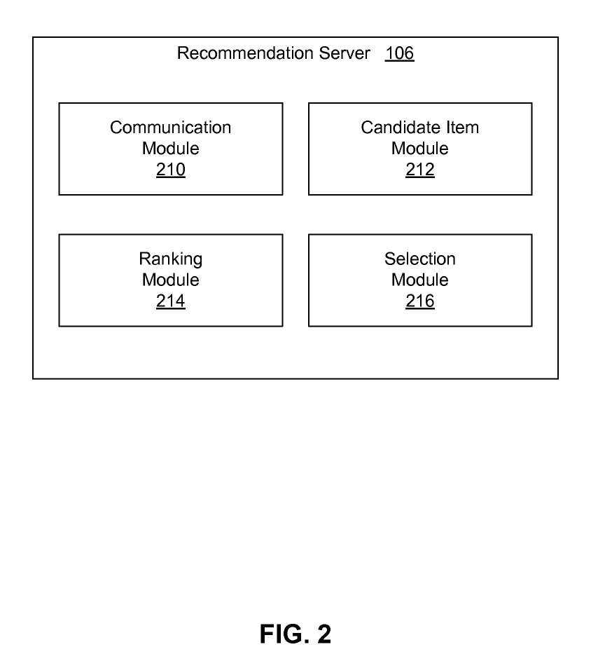

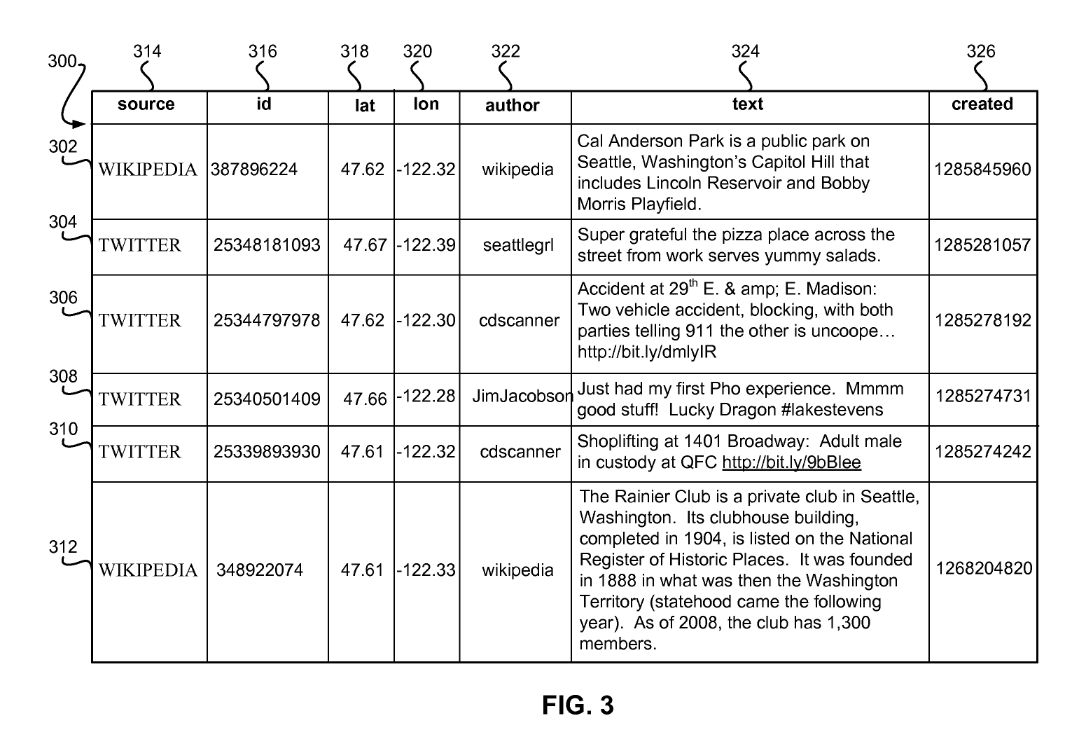

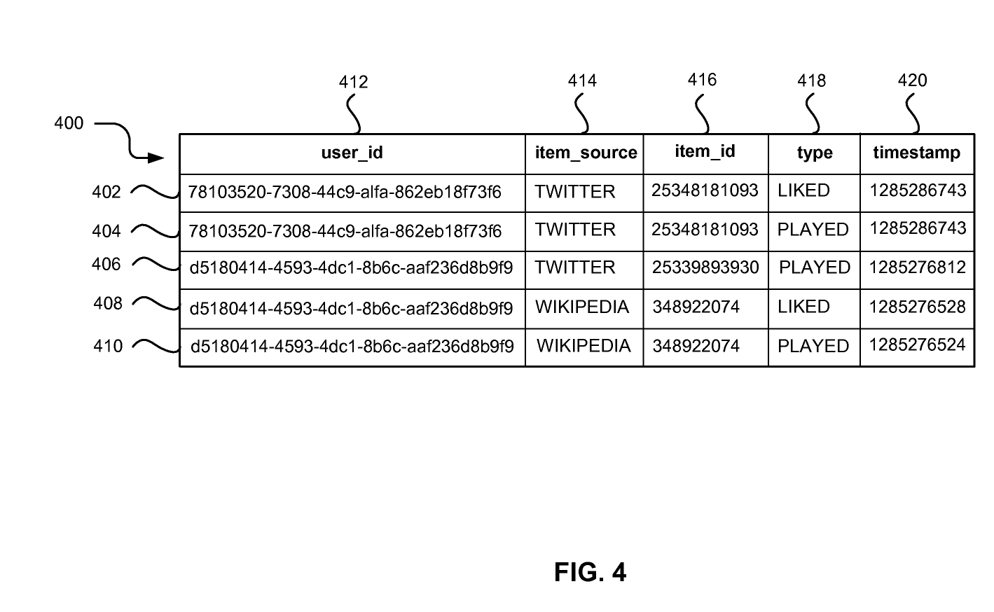

Referring now to FIG. 1 there is shown a content-based recommender system 100 for recommending geotagged items. The system 100 includes one or more computing devices, e.g., mobile devices 102, in communication with a recommendation server 106 over a network 104. The recommendation server 106 is coupled to an item server 108. One embodiment of the recommendation server 106 is described with respect to FIG. 2. The item server 108 has access to an item database 112, the format of which is described more fully with respect to FIG. 3. Similarly, the recommendation server 106 has access to an event database 110, the format of which is described more fully with respect to FIG. 4.

In the illustrated embodiment of FIG. 1, the mobile device 102 obtains, at a minimum, a location fix and a heading. In this embodiment, the location fix is given as a latitude-longitude pair in decimal degrees and the heading is given in degrees East of true North. The mobile device 102 may also override a radius value, defaulted to 6 kilometers in this implementation, which defines a geographic area of interest centered on the location fix. Alternative embodiments of the disclosed recommender can obtain additional information, such as a speed and a time range of interest. Various embodiments may have the mobile device 102 obtain values for the aforementioned parameters through sensors, manual input, or some combination thereof

Still referring to the illustrated embodiment of FIG. 1, the obtained values and an associated identifier (e.g., a “cookie” or “user ID”) for identifying the mobile device 102 are transmitted to the recommendation server 106 via the network 104. The recommendation server 106 issues a query to the item server 108 for items within the geographic area of interest specified by the mobile device 102. In an alternative embodiment, the query is expanded to a spatiotemporal area of interest. The item server 108 searches through a plurality of items stored in the item database 112, finds items satisfying the query, and returns them to recommendation server 106. In the embodiment illustrated, the item database 112 is pre-populated with items acquired from digital sources outside the scope of the system 100. In an alternative embodiment, the item server 108 continuously updates the item database 112 with items directly acquired from external sources. Yet another embodiment has the mobile device 102 acquire items for inclusion in the item database 112 at the behest of the item server 108.

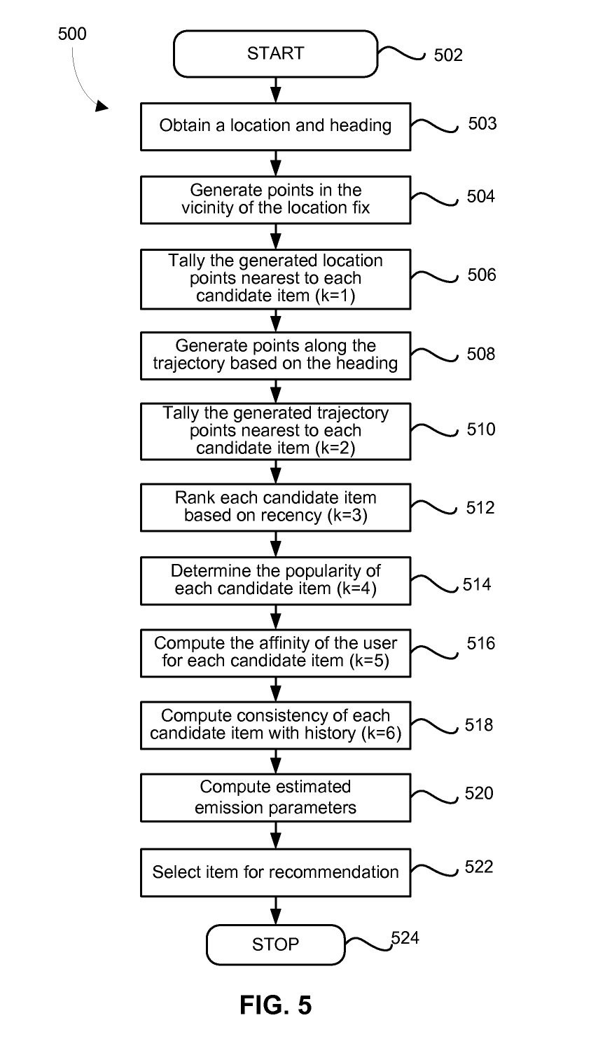

Again referring to the illustrated embodiment of FIG. 1, once the recommendation server 106 accepts the items from the item server 108, a filtering step takes place. More specifically, the recommendation server 106 uses the user ID of the mobile device 102 in conjunction with the event database 110 to censor any returned items that were previously recommended (e.g., “PLAYED”) to the mobile device 102. In some implementations, the filtering step only filters out recently recommended items. The result of the filtering step is an array of candidate items. The recommendation server 106 then runs a recommendation process on the candidate items, whereby at least one candidate item is selected for recommendation. The details of an exemplary recommendation process are more fully disclosed below with reference to FIG. 5. In addition, the recommendation server 106 records all of the recommended items as PLAYED in the event database 110 and sends them to the mobile device 102. Note that if, after the filtering step, the array of candidate items is empty, an error code or an artificial item explaining that there are no items currently available in the region of interest is sent to the mobile device 102 in lieu of recommendations.

Referring back to FIG. 1, the mobile device 102 receives the recommended items from the recommendation server 106 and emits them in audible form. In this embodiment, the mobile device 102 relies on a native TTS service to read the textual portion of a recommended item aloud. In another embodiment, an intermediate step is included in which the TTS service converts the text to an audio file for playback. In other embodiments, the TTS service is on the server-side and recommendations are shipped back with either embedded audio files or references to pre-generated audio files hosted elsewhere. The emission of recommended items is not limited to audio files. In other embodiments, the emitted items are presented to the end user in the form of video, text message, or any other media output format known in the art.

During playback, and for a short time thereafter, the mobile device 102 solicits feedback for the recommended item. If feedback is given, the mobile device 102 sends it to the recommendation server 106, along with the user ID and the identity of the item. The recommendation server 106 records the feedback as an event in the event database 110. In the illustrated embodiment, it is only possible to give positive feedback (e.g., a “LIKED”) on a recommended item. Alternative embodiments permit negative feedback (e.g., a “DISLIKED”), and numerical feedback scores (e.g., scoring a recommended item on a scale from one to five). In further embodiments, information pertaining to the state of the mobile device 102 at the time of feedback (e.g., location fix, heading, speed, etc.) accompanies the data sent to the recommendation server 106.

The mobile device 102 shown in FIG. 1 can be any electronic device that is locatable in some manner, and which is capable of presenting a recommended item, such as a smart phone (e.g., Android Phone, iPhone, etc.) running a software application (app or applet) carrying out the appropriate methods described herein. In the illustrated embodiment, the recommended item is presented in audible form via a user's smart phone. Further, the network 104 can be a wireless network, a Local Area Network (LAN), a Wide Area Network (WAN), or a combination of interconnected networks, up to and including the Internet. In one embodiment where internet-related technology is used, the services provided by the recommendation server 106 and the item server 108 are delivered over Hypertext Transfer Protocol (HTTP) as Representational State Transfer (REST) Application Programming Interfaces (APIs), with responses encoded in JavaScript Object Notation (JSON). The event database 110 and the item database 112 can be relational (e.g., PostgreSQL) or non-relational (e.g., Google App Engine's datastore) in nature; in some environments, the item database 112 benefits from the inclusion of a spatial index (e.g., R-tree, kd-tree, etc.). It should be apparent to those skilled in the art that other implementations of the system 100 are possible.

### Exemplary Embodiment

Turning now to FIG. 2, an exemplary embodiment of a recommendation server 106 is shown. The recommendation server 106 comprises a communication module 210, a candidate item module 212, a ranking module 214, and a selection module 216. The communication module 210 supports communication between the recommendation server 106 and the other entities in the content based recommender system 100, as well as managing data flow between the other modules of the recommendation server 106.

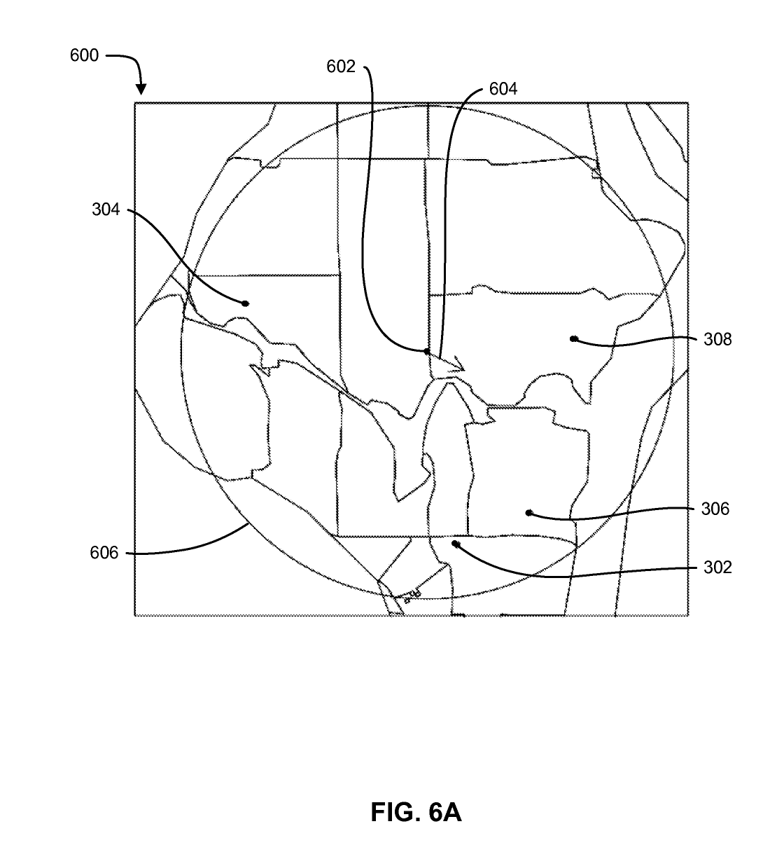

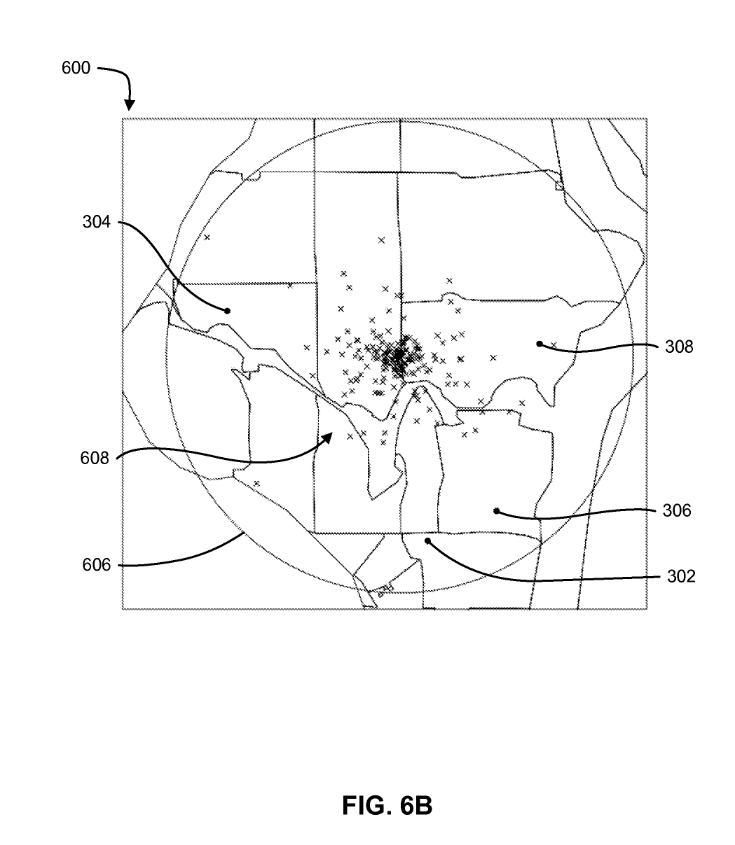

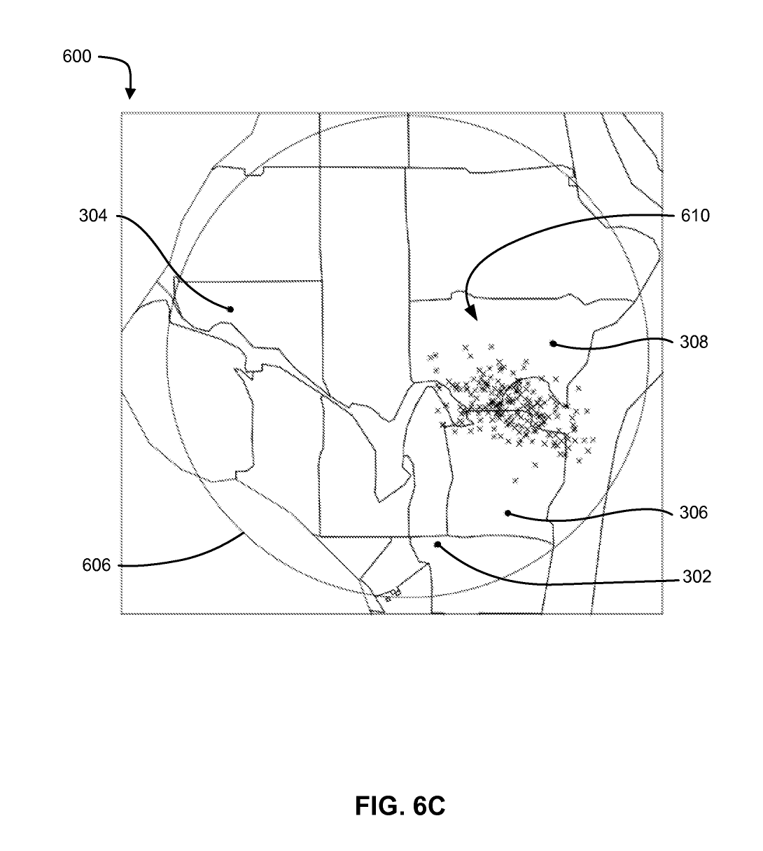

The candidate item module 212 identifies candidate items stored in the item database 112 that are within the geographic area of interest. Candidate items are discussed in greater detail below, with reference to FIG. 3. Ranking module 214 assigns scores and/or ranks to the candidate items, as described in further detail below with reference to FIGS. 5 and 6A-C. The selection module 216 selects one or more candidate items to present to a user based on the output of the ranking module. This is described in further detail below with reference to FIGS. 5, 6A-C and 7.

Turning now to FIG. 3, there is shown an item table 300 containing some exemplary items. The table 300 is comprised of rows 302, 304, 306, 308, 310, and 312, each corresponding to a different item. Each row is divided into the following columns: a source column 314 indicating the external source of the item; an ID column 316 containing an opaque identifier that uniquely identifies the item within the context of the source; a latitude column 318 and a longitude column 320 which, when taken together, pinpoint where the item was created or what location its text refers to; an author column 322 containing an opaque identifier that uniquely identifies the item's author within the context of the source; a text column 324 containing free-text and/or references, such as Uniform Resource Locators (URLs), to other media; and a created column 326 indicating when the item was posted to the source, here given in seconds since Jan. 1, 1970 (the UNIX Epoch). So, by way of example, row 302 shows an item derived from a Wikipedia entry, version 387896224, geotagged to 47.62° N 122.32° W by the Wikipedia collective, about Cal Anderson Park in Seattle, posted on Thu, 30 Sep. 2010 11:26:00 GMT.

Referring now to FIG. 4, there is shown an event table 400 containing exemplary events generated during the operation of the illustrated embodiment. A user ID column 412 contains Universally Unique Identifiers (UUIDs) that are associated with specific mobile devices. An item source column 414 and an item ID column 416 together form a foreign key that links to the primary key formed by the source column 314 and the ID column 316 of the item table 300 shown in FIG. 3. A type column 418 indicates the type of event recorded (e.g., PLAYED, LIKED), and a timestamp column 420 indicates when, in seconds since the Unix Epoch, the event occurred. The rows of table 400 represent individual events, some of which, like rows 402 and 408, represent feedback generated by the user indicated in column 412, and some of which, like rows 404, 406, and 410, represent recommendations that were presented to the user. Thus, for example, in row 402 it can be seen that the end-user of a mobile device with cookie 78103520-7308-44c9-alfa-862eb18f73f6 LIKED the item represented by row 304 in FIG. 3, as indicated by the two rows indicating the same item ID. The entry in column 420 for this row shows that the user LIKED the item on Fri, 24 Sep. 2010 00:05:49 GMT.

FIG. 3 and FIG. 4 are intended to merely aid a prospective implementer. Those skilled in the art will realize that in other embodiments, the database will be structured differently, for example by using surrogate keys; containing more (or less) information; by being further normalized, etc. The rows and columns of the illustrated tables are examples, and are not intended to be limiting in scope.

Turning now to FIG. 5, it is a flow diagram illustrating an exemplary process for making a recommendation 500 carried out by an exemplary recommender. The process 500 starts 502, wherein a model is initialized, defined in terms of the following variables:
j=1,2, . . . , m: The index of each candidate item, where m is the total number of candidate items.
k=1,2, . . . , K: The index of each feature to be used in determining which of a plurality of recommendations to present, where K=6 in the illustrated embodiment.
θₖ=θ₁ₖ, θ₂ₖ, . . . , θₘₖ]^{T}: The vector of m emission parameters associated with feature k. The parameters are constrained to be non-negative and sum to one (i.e., obey unit-simplex constraints).
Yₖ˜CATEGORICAL (θₖ): The discrete, categorical random variable representing the emission of a candidate item for feature k.

Based on the above definitions, the probability of emitting candidate item j for feature k is given by the following probability mass function:

f_{Y}(j;θₖ)=θⱼₖ

Furthermore, assuming that the random variable X is a mixture of the preceding K categorical random variables, the probability of emitting candidate item j given the entire model of features is:

$${f}_{X} ( j ) = {\sum }_{k = 1}^{K} {a}_{k} {f}_{Y} ( j ; {θ}_{k} )$$

where the mixture weights (aₖ) obey unit-simplex constraints. The rest of the process 500 is concerned with estimating the m·K emission parameters and using them to recommend candidate items. The process 500l proceeds by calculating vectors of counts from actual or simulated data for each feature:

nₖ=[n₁ₖ, n₂ₖ, . . . , nₘₖ]^{T}

A location fix 602 and heading 604 are obtained 503 from a mobile device, an example of which is illustrated by FIG. 6A, where there is shown a map 600 of zip codes for the North Seattle area. The latitude of the location fix 602 is 47.6591° N, the longitude of the location fix 602 is 122.3287° W, and the heading 604 is 116.0° East of true North. A geographic area of interest 606 is shown, which in this embodiment is a circle with a radius (r) of 6.0 kilometers, centered on the location fix 602. Within the geographic area of interest 606, the points described by rows 302, 304, 306, and 308 of FIG. 3 are individually plotted. These rows serve as exemplary candidate items in the discussion that follows.

Referring again to FIG. 5, N₁ points are generated 504 in the vicinity of the location fix 602. An exemplary method for doing this is described below in further detail, with reference to FIG. 6B.

In FIG. 6B, the same map 600 is shown, including geographic area of interest 606. As before, rows 302, 304, 306, and 308 are used as candidate items. Additionally, there is a cluster 608 of N₁=200 generated points plotted on the map 600. Each point is generated by first making an independent draw from a uniform distribution of bearings (B):

B˜Unif(a, b)

B is defined as the angle from the location fix 602 to the point being generated, and it is specified in degrees East of true North. Hence, the uniform distribution is parameterized with a=0 and b=360.

Next, there is an independent draw from an exponential distribution of scaling factors:

S˜Exp (λ)

and distance (D) is then computed as:

D=r·S

where r is the radius of the given geographic area of interest 606. The exponential distribution is parameterized with λ=6.60775 in the illustrated embodiment, since this value assures that more than 99% of the generated points lie within the area of interest 606. Other parameter values are possible; however, care must be taken to prevent too many generated points from falling outside the area of interest 606. In alternative embodiments, different distance decay models are used, e.g., a uniform distribution between the location fix 602 and the outside edge of the area of interest 606, or the probability of a point being generated at D being inversely proportional to D².

Given the location fix 602 and values for B and D, there is enough information to finish generating a point. This is accomplished using methods known in the art; for example, as in Williams, E. (2010), “Lat/lon given radial and distance”, Aviation Formulary V1.45, retrieved from http://williams.best.vwh.net/avform.htm.

Returning to FIG. 5, the distance between each generated point and each candidate item in the vicinity of the location fix is computed, and the numbers of generated points closest to each of the candidate items are tallied 506. In different embodiments, different methods are used to determine which candidate item a point is nearest to, for example, straight-line or great-circle (i.e., orthodromic) distances. In the illustrated embodiment, distances are calculated using the haversine formula. A description of the haversine formula exists in Sinnott, R. W. (1984), “Virtues of the Haversine”, Sky and Telescope 68(2): 159. Other distance formulae well known in the art may be employed. The result of these distance calculations is a set of m counts:
nⱼ₁=the number of generated “vicinity” points nearer to candidate item j than any other candidate item
   where

$${\sum }_{i = 1}^{m} {n}_{i 1} = {N}_{1} .$$

e.g., for each candidate item j, there is a count of the number of generated points that are closer to it than any other candidate item, and the sum of those counts will be exactly equal to the total number of generated points, N₁.

Referring back to FIG. 5, N₂ points are generated 508 along a trajectory determined by the heading 604 that was obtained 503 from the mobile device 102. An exemplary method for generating these points is described below in further detail, with reference to FIG. 6C.

In FIG. 6C, a cluster of points 610 (different to the previous cluster 608 of FIG. 6B) is shown. The cluster 610 is made up of N₂=200 generated points. Each point is generated by first making an independent draw from a bivariate normal distribution of vectors:

X˜N(μ, Σ)

A value for X, in conjunction with the given location fix 602, can be converted into a latitude-longitude pair via the methods of Williams (2010). More specifically, if:

X=[X₁, X₂]^{T}

then B, in radians measured clockwise from the x-axis, is computed as:

B=a tan2 (X₂, X₁)

Distance is computed as the length or magnitude of the random vector. Assuming a is a heading specified in radians measured clockwise from the x-axis, not degrees East of true North, and r is the radius of the geographic area of interest, then the parameters of the bivariate normal distribution are:

$$μ = {[ \frac{r \cdot cos ( α )}{2} , \frac{r \cdot sin ( α )}{2} ]}^{T}$$

$$and$$

$$Σ = U Λ {U}^{T}$$

$$Where$$

$$U = [ \begin{matrix}cos ( α ) & sin ( α ) \\ - sin ( α ) & cos ( α )\end{matrix} ]$$

$$and$$

$$Λ = [ \begin{matrix}{( \frac{r}{6} )}^{2} & 0 \\ 0 & {( \frac{r}{12} )}^{2}\end{matrix} ]$$

The above described model and parameter definitions were chosen such that the N₂ points are clustered around a point, at which the mobile device 102 is likely to be in the near future, based on the location fix 602 and heading 604. This can be seen from FIG. 6C, where all of the generated points lie within a segment of the circular area of interest 606 that is in front of the mobile device 102 with respect to the determined heading 604. In other embodiments, different parameter definitions, and models other than a bivariate normal distribution, are used to generate 508 the set of N₂ points based on the heading 604.

In further embodiments, data from a geographic (i.e., map) database is used to supplement the location fix and heading data when generating points 504 and 508. For example, in one such embodiment points are favorably generated in regions with a direct road connection to the location fix, and points are less likely to be generated in inaccessible areas such as lakes.

Referring again to FIG. 5, for each generated point, the distance between the point and each candidate item in the vicinity of the location fix 602 is computed, and the numbers of generated points closest to each of the candidate items are tallied 510. The result is a set of m counts:
nⱼ₂=the number of generated ^{“}trajectory” points nearer to candidate item j than any other candidate item,
   where

$${\sum }_{i = 1}^{m} {n}_{i 2} = {N}_{2} .$$

As described earlier with regards to the set of N₁ points, in different embodiments, different methods are used to determine which candidate item a given point is nearest to.

Candidate items are ranked 512 according to recency. For example, the candidate items are ordered from oldest to newest in terms of when they were created and then, in the simplest case, they are assigned values 1, 2, . . . , m. Thus:
nⱼ₃=the “recency” rank of candidate item j with respect to the other candidate items.
   Occasionally, candidate items will have creation times that are equal. There are several ways to assign ranks in the presence of such ties. For instance, in the illustrated embodiment, ties are resolved by assigning an average rank to each candidate item within a tied group. In an alternative embodiment, ties are broken by random selection. In further embodiments, other recency ranking systems are used, for example, values of 1², 2², . . . , m² are used, thereby comparatively increasing the significance of newer candidate items compared to older ones.

Still referring to FIG. 5, the popularities of each of the candidate items are determined 514 from event data. This is accomplished by counting the appropriate events in an event database. In the illustrated embodiment, the appropriate events are recorded instances of users of the system having LIKED the candidate item. The result is that:
nⱼ₄=the number of times that candidate item j has been LIKED.
   In embodiments that enable users to provide negative feedback, a combination of the positive and negative feedback is used, e.g., the difference between the numbed of LIKED and DISLIKED, with results of less than zero being treated as zero. Similarly, if numerical feedback is provided, a combination method is used, such as summing all feedback scores provided.

Continuing to refer to FIG. 5, the affinity of a given user ID for a candidate item is computed 516. Again, this is accomplished by counting appropriate events in an event database. In the illustrated embodiment, appropriate events are recorded instances of the specific user ID having LIKED items that are similar to the candidate item, wherein user ID is an identifier of the end-user on whose behalf the process 500 is being carried out. Items are considered “similar” to a candidate item if they share both the same source and the same author. The result is that:
nⱼ₅=the number of times that items “similar” to candidate item j have been LIKED by the given user ID.
   In other embodiments, different measures of a candidate item's affinity with the specific user ID are used. For example, if the user is also given a DISLIKE option for presented items, selection of DISLIKE decreases the user's affinity with similar candidate items in future. Similarly, if the user is asked to rate presented items with a score from one to five, the sum (or other combination) of the user's provided feedback scores for similar items is used. In further embodiments, different methods for determining whether a candidate item is similar to a previously presented item for which the user ID has recorded feedback are used, such as comparing metadata associated with the candidate items that indicate classifications of the candidate items, e.g., restaurant, view point, museum, or site of historical interest. In another embodiment, the content of the previously presented item and the candidate item are compared to obtain a measure of similarity, e.g., by counting the number of words that appear in both items compared with the number of words that appear in just one of the items.

A numerical value indicating consistency of a specific candidate item relative to candidate items that have been previously presented to the user is computed 518. In the illustrated embodiment, this is achieved by counting the total number of records in the event database indicating that items “similar” (as defined previously) to the candidate item have been PLAYED to the user. The result is that:
nⱼ₆=the number of times that items “similar” to candidate item j have been PLAYED to the given user ID.

In the illustrated embodiment, there is no consideration of when items were LIKED or PLAYED when computing affinity and consistency (516 and 518). In an alternative embodiment, only events that occurred within a certain timeframe (e.g., the last month) are considered. In another embodiment, recent events are weighted to count more than older events.

Once the complete set of vectors of counts for all features and all candidate items have been determined, vectors of estimated emission parameters are computed 520. The vector of estimated emission parameters associated with feature k is computed 520 as follows:

$${\hat{θ}}_{k} = {[ \frac{{n}_{1 k} + \frac{2}{m}}{{\sum }_{i = 1}^{m} {n}_{ik} + 2} , \frac{{n}_{2 k} + \frac{2}{m}}{{\sum }_{i = 1}^{m} {n}_{ik} + 2} , … , \frac{{n}_{mk} + \frac{2}{m}}{{\sum }_{i = 1}^{m} {n}_{ik} + 2} ]}^{T} .$$

This represents a smoothed maximum likelihood estimate (MLE) for θₖ, utilizing Lidstone smoothing. This method is described in further detail in the eNotes article “Rule of succession” (http://www.enotes.com/topic/Rule_of_succession) which in incorporated herein by reference in its entirety. In other embodiments, other smoothing methods are used.

Once all estimated emission parameters have been computed 520, a candidate item for recommendation (j*) is selected 522, in accordance with the following rule:

$$\begin{matrix}{j}^{*} = {argmax}_{j} {f}_{X} ( j ) \\ = {argmax}_{j} {\sum }_{k = 1}^{K} {a}_{k} {f}_{Y} ( j ; {\hat{θ}}_{k} )\end{matrix}$$

In the illustrated embodiment, the mixture weights are of the form:

$${a}_{k} = \frac{1}{K} .$$

meaning that all six features are equally weighted.

In other embodiments, the mixture weights are algorithmically learned from data, set by the end-user via Graphical User Interface (GUI) elements (e.g., sliders) on the mobile device 102, or otherwise determined by appropriate methods known in the art. Although the basic rule, as used in the illustrated embodiment, is to recommend the candidate item with the highest emission probability, other recommendation strategies may be adopted. For instance, candidate items with arbitrarily high emission probabilities may be selected for recommendation. In order to add stochasticity to the process 500, in some embodiments a candidate item is sampled from the mixture distribution and presented as the recommended item. In one such embodiment, a candidate item is selected in response to one or more randomly generated numbers, with candidate items that yield higher values for fₓ(j) being more likely to be selected. Regardless of how the recommended item or recommended items are chosen, the process 500 terminates 524 and returns the selected candidate item or items.

In some embodiments, the above probability calculations are done in logarithmic space in order to ensure numerical stability. In such embodiments where logarithmic space is used, the final summation should be done as a log sum of exponentials.

Although the illustrated embodiment enumerates six features, alternative embodiments using more, less, or different features are possible, as should be apparent to one of skill in the art. Additional features considered in further embodiments include, but are not limited to, ranking candidate items by source quality, computing the affinity of a group for a candidate item, and the inclusion of sponsorship as a feature, wherein the amount of advertising money spent on a candidate item influences its recommendation likelihood.

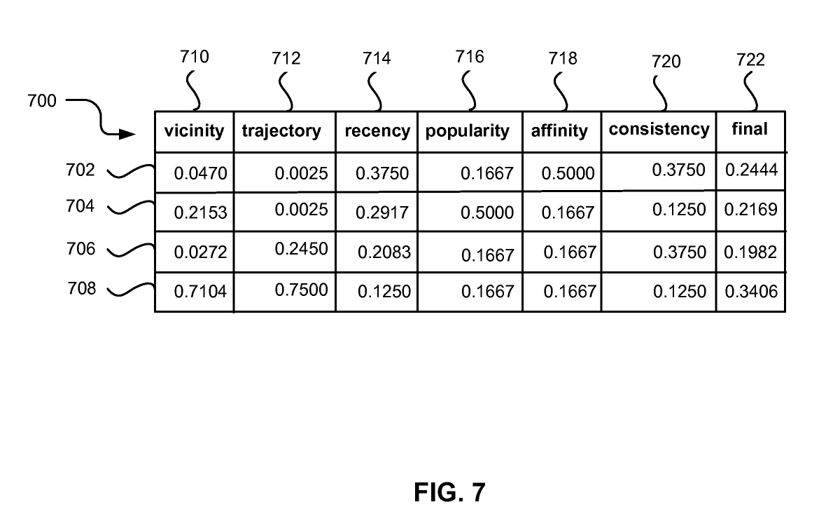

FIG. 7 presents a table 700 containing a worked example of the recommendation process being applied to candidate items on behalf of a user with user ID d5180414-4593-4dc1-8b6c-aaf236d8b9f9. Rows 702, 704, 706, and 708 represent candidate items that correspond with rows 302, 304, 306, and 308 of FIG. 3, respectively. There are also the following columns, each of which represents one of the features used in the illustrated embodiment: a vicinity column 710, a trajectory column 712, a recency column 714, a popularity column 716, an affinity column 718, and a consistency column 720. A final column 722 holds the computed emission probabilities. The first row 702 shows the conditional emission probabilities under the features of vicinity (0.0470), trajectory (0.0025), recency (0.3750), popularity (0.1667), affinity (0.5000), and consistency (0.3750). The final, or conditional, emission probability for the first row 702 is 0.2444, assuming uniform mixture weights are used. This probability is less than 0.3406, which indicates that the candidate item represented by the final row 708 is better suited for recommendation. This follows, since the item represent by the final row 708 is both closer to, and along the trajectory of, user ID d5180414-4593-4dc1-8b6c-aaf236d8b9f9, as can be seen with reference to FIG. 6A. The final emission probabilities given in the second row 704 and the third row 706 are both lower than that in the final row 708. This makes sense, as both candidate items 304 and 306 are further away from the mobile device 102 and further from the trajectory.

The system described has several advantages over other recommender systems. The use of a funneling approach enables a continuous stream of relevant recommendations to be provided, without any potential recommendations having to be considered and blocked. The system makes intelligent “guesses,” even when the amount of feedback data is very limited. As a result, it does not require a long calibration period before it becomes useful to the end user. In some embodiments, the system is configured such that items determined to be of low relevance are still presented to the end user. If the determination was incorrect, and the user in fact likes the recommendation, the parameters and weightings used to select items in future are updated. In other embodiments, both the end user and the system provider can update these parameters and weightings manually in real time, giving a recommender system a great deal of versatility.

### Computing Machine Architecture

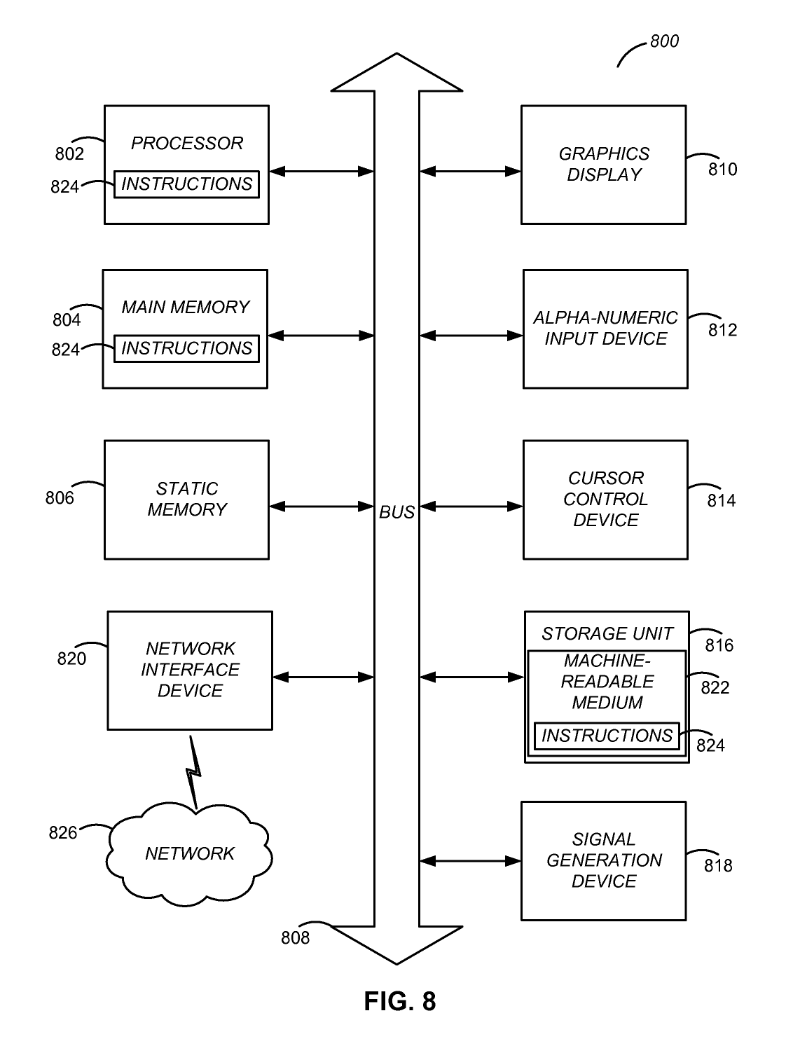

Turning next to FIG. 8, it is a block diagram illustrating components of an example machine able to read instructions from a machine-readable medium and execute them in a processor (or controller). Specifically, FIG. 8 shows a diagrammatic representation of a machine in the example form of a computer system 800 within which instructions 824 (e.g., software) for causing the machine to perform any one or more of the methodologies discussed herein may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 824 (sequential or otherwise) that specify actions to be taken by that machine. Further, while only a single machine is illustrated, the term “machine” shall also be taken to include any collection of machines that individually or jointly execute instructions 824 to perform any one or more of the methodologies discussed herein.

The example computer system 800 includes a processor 802 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 804, and a static memory 806, which are configured to communicate with each other via a bus 808. The computer system 800 may further include graphics display unit 810 (e.g., a plasma display panel (PDP), a liquid crystal display (LCD), a projector, or a cathode ray tube (CRT)). The computer system 800 may also include alphanumeric input device 812 (e.g., a keyboard), a cursor control device 814 (e.g., a mouse, a trackball, a joystick, a motion sensor, or other pointing instrument), a storage unit 816, a signal generation device 818 (e.g., a speaker), and a network interface device 820, which also are configured to communicate via the bus 808.

The storage unit 816 includes a machine-readable medium 822 on which is stored instructions 824 (e.g., software) embodying any one or more of the methodologies or functions described herein. The instructions 824 (e.g., software) may also reside, completely or at least partially, within the main memory 804 or within the processor 802 (e.g., within a processor's cache memory) during execution thereof by the computer system 800, the main memory 804 and the processor 802 also constituting machine-readable media. The instructions 824 (e.g., software) may be transmitted or received over a network 826 via the network interface device 820.

While machine-readable medium 822 is shown in an example embodiment to be a single medium, the term “machine-readable medium” should be taken to include a single medium or multiple media (e.g., a centralized or distributed database, or associated caches and servers) able to store instructions (e.g., instructions 824). The term “machine-readable medium” shall also be taken to include any medium that is capable of storing instructions (e.g., instructions 824) for execution by the machine and that cause the machine to perform any one or more of the methodologies disclosed herein. The term “machine-readable medium” includes, but not be limited to, data repositories in the form of solid-state memories, optical media, and magnetic media.

### Additional Configuration Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms, all of which may be implemented using, software (e.g., code embodied on a machine-readable medium or in a transmission signal), hardware modules, firmware, or a combination thereof, e.g., as described with FIGS. 1-5 and 7. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor, e.g., 802, or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors, e.g., 802, that are temporarily configured (e.g., by software instructions, e.g., 824) or permanently configured to perform the relevant operations. Whether temporarily or permanently configured, such processors may constitute processor-implemented modules that operate to perform one or more operations or functions.

The one or more processors, e.g., 802, may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., computer memory 804). These algorithms or symbolic representations are examples of techniques used by those of ordinary skill in the data processing arts to convey the substance of their work to others skilled in the art. As used herein, an “algorithm,” e.g., as described with FIGS. 5 and 6A-C, is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for recommending geotagged items in the vicinity of an end user, based on a plurality of factors, through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for presenting geotagged items, the method comprising:
obtaining a location fix and a heading;
retrieving, from a database, a plurality of candidate items in the vicinity of the location fix;
generating a first set of location points in the vicinity of the location fix;
generating a second set of location points, based on the location fix and the heading;
for each of the plurality of candidate items, computing a first score based on the first set, and a second score based on the second set; and
selecting, using a processor, one of the plurality of candidate items based on the first scores and the second scores.

2. The method of claim 1, further comprising computing a third score for each of the candidate items based on a measure of recency of each candidate item, wherein selecting one of the plurality of candidate items is further based on the third scores.

3. The method of claim 1, further comprising computing a fourth score for each of the candidate items based upon a measure of popularity of each candidate item, wherein selecting one of the plurality of candidate items is further based on the fourth scores.

4. The method of claim 1, further comprising computing a fifth score for each of the candidate items based upon a measure of affinity with an end user of each candidate item, wherein selecting one of the plurality of candidate items is further based on the fifth scores.

5. The method of claim 1, further comprising computing a sixth score for each of the candidate items based upon a measure of similarity with previous items presented to an end user of each candidate item, wherein selecting one of the plurality of candidate items is further based on the sixth scores.

6. A method for presenting geotagged items, the method comprising:
retrieving, from a database, a plurality of candidate items;
for each of the candidate items, computing a plurality of scores based on a plurality of factors associated with the candidate item; and
selecting, using a processor, one of the candidate items for presentation to the end user, based at least in part on the plurality of scores.

7. The method of claim 6, wherein the selecting comprises:
computing a probability for each of the candidate items, the probability based on the plurality of scores computed for that candidate item; and
selecting one of the candidate items based on the computed probabilities.

8. The method of claim 6, further comprising obtaining a first location fix, and wherein the retrieving comprises:
comparing a second location fix associated with a potential candidate item in the database with the first location fix; and
responsive to a correspondence between the first location fix and the second locations fix, selecting the potential candidate item as one of the plurality of candidate items.

9. A system for presenting geotagged items, the system comprising:
a candidate item module, configured to retrieve, from a database, a plurality of candidate items in the vicinity of a location fix;
a ranking module, configured to compute a plurality of scores for each of the plurality of candidate items, wherein the plurality of scores are based on a plurality of factors associated with each candidate item; and
a selection module, configured to select one of the plurality of candidate items based on the plurality of scores.

10. The system of claim 9, wherein the plurality of factors comprises:
a measure of proximity of each candidate item to a first set of generated location points in the vicinity of the location fix; and
a measure of proximity of each candidate item to a second set of generated location points, wherein the second set are generated based on the location fix and a heading.

11. The system of claim 9, wherein the plurality of factors comprises a measure of recency of each candidate item.

12. The system of claim 9, wherein the plurality of factors comprises a measure of popularity of each candidate item.

13. The system of claim 9, wherein the plurality of factors comprises a measure of affinity with an end user of each candidate item.

14. The system of claim 9, wherein the plurality of factors comprises a measure of similarity with previous items presented to an end user of each candidate item.

15. A non-transitory computer readable medium configured to store instructions, the instructions when executed by a processor cause the processor to:
obtain a location fix and a heading;
retrieve, from a database, a plurality of candidate items in the vicinity of the location fix;
generate a first set of location points in the vicinity of the location fix;
generate a second set of location points, based on the location fix and the heading;
compute a first score and a second score for each of the plurality of candidate items, the first score based on the first set, and the second score based on the second set; and
select one of the plurality of candidate items, based on the first scores and the second scores.

16. The computer readable medium of claim 15, wherein the instructions further comprise instructions to compute a third score for each of the candidate items based on a measure of recency of each candidate item, and wherein selecting one of the plurality of candidate items is further based on the third scores.

17. The computer readable medium of claim 15, wherein the instructions further comprise instructions to compute a fourth score for each of the candidate items based upon a measure of popularity of each candidate item, and wherein selecting one of the plurality of candidate items is further based on the fourth scores.

18. The computer readable medium of claim 15, wherein the instructions further comprise instructions to compute a fifth score for each of the candidate items based upon a measure of affinity with an end user of each candidate item, and wherein selecting one of the plurality of candidate items is further based on the fifth scores.

19. The computer readable medium of claim 15, wherein the instructions further comprise instructions to compute a sixth score for each of the candidate items based upon a measure of similarity with previous items presented to an end user of each candidate item, and wherein selecting one of the plurality of candidate items is further based on the sixth scores.

20. The computer readable medium of claim 15, wherein the instructions further comprise instructions to compute a probability for each of the candidate items, the probability based on the first score and the second score, and wherein the one of the candidate items is selected based on the computed probabilities.
